(19) United States
(12) Patent Application Publication
(10) Pub. No.: US 2019/0354460 A1
(43) Pub. Date: Nov. 21, 2019

(54) ANOMALY DETECTION MANAGEMENT APPARATUS AND ANOMALY DETECTION MANAGEMENT METHOD

(71) Applicant: FUJITSU LIMITED, Kawasaki-shi (JP)

(72) Inventor: MASAO YAMAMOTO, Kawasaki (JP)

(73) Assignee: FUJITSU LIMITED, Kawasaki-shi (JP)

(21) Appl. No.: 16/400,080

(22) Filed: May 1, 2019

(30) Foreign Application Priority Data
May 16, 2018 (JP) 2018-094679

(51) Int. Cl. G06F 11/34

(52) U.S. Cl. CPC G06F 11/3495; G06F 11/3409; G06F 11/3447

(57) ABSTRACT

An anomaly detection management apparatus includes one or more memories, and one or more processors configured to, perform acquisition of a plurality of pieces of performance information that represent a running state of a computer, perform identification of a plurality of features that represent an occurrence trend of each piece of the plurality of pieces of performance information, perform classification of the plurality of pieces of performance information in accordance with the plurality of features, for each group generated by the classification, perform selection of specific piece of performance information as a criterion of anomaly detection from one or more pieces of performance information included in each group, and notify the specific piece of performance information to the computer and cause the computer to perform anomaly detection by using the specific piece of performance information.

### CROSS-REFERENCE TO RELATED APPLICATION

This application is based upon and claims the benefit of priority of the prior Japanese Patent Application No. 2018-94679, filed on May 16, 2018, the entire contents of which are incorporated herein by reference.

### FIELD

The embodiments discussed herein are related to an anomaly detection management technique.

### BACKGROUND

In recent years, a form of offering services called cloud computing that offers computational resources and services that operate on the computational resources through a computer network such as the Internet has been spread. In the cloud computing, in association with increase in the degree of integration due to virtualization of a physical server, plural users are affected at the time of occurrence of failure. For this reason, the provider of services in the cloud computing is desired to rapidly inform the users of the failure.

In an environment that implements such cloud computing, for example, in a cloud environment, a cause of a performance anomaly of a virtual machine (VM) is interference from another virtual machine that shares the same physical environment in some cases. The performance here is, in the case of hardware performance, the access latency and bandwidth of memory and network, the performance of arithmetic processing of a central processing unit (CPU) per unit time, the number of times of input-output (IO) of an IO per unit time, and so forth, for example. Furthermore, as application performance, the response performance of a Web server, the throughput that is the transaction processing performance of a database (DB), and so forth are included in the performance here.

In the case of failure the cause of which is influence from another virtual machine in the cloud environment, the occurrence of a problem of the failure is intermittent and reproduction thereof is difficult in many cases because the influence from another virtual machine is not steadily received. For such a reason, when a performance anomaly occurs in the cloud environment, it is preferable to rapidly carry out an inspection of the cause on site. Thus, in the cloud environment, it is important to carry out performance anomaly detection with immediacy.

Here, as a technique of anomaly detection, there is a related art in which pieces of performance information are collected from pieces of performance information of a computer in accordance with the degree of priority and a threshold that are defined in advance and monitoring of the computer is carried out based on the collected pieces of performance information. Furthermore, there is a related art in which, when a model is created, a target model of creation and accumulated reference models are compared based on a representative index to identify the reference model having a similar structure and the target model is created by using a partial structure of the identified reference model.

For example, related arts are disclosed in Japanese Laid-open Patent Publication No. 2008-108120 and Japanese Laid-open Patent Publication No. 2009-266158.

### SUMMARY

According to an aspect of the embodiment, an anomaly detection management apparatus includes one or more memories, and one or more processors configured to, perform acquisition of a plurality of pieces of performance information that represent a running state of a computer, perform identification of a plurality of features that represent an occurrence trend of each piece of the plurality of pieces of performance information, perform classification of the plurality of pieces of performance information in accordance with the plurality of features, for each group generated by the classification, perform selection of specific piece of performance information as a criterion of anomaly detection from one or more pieces of performance information included in each group, and notify the specific piece of performance information to the computer and cause the computer to perform anomaly detection by using the specific piece of performance information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic configuration diagram of an information processing system;

FIG. 2 is a block diagram of an anomaly detection management apparatus;

FIG. 3 is a diagram representing one example of features using OS mode and USER mode regarding performance indexes;

FIG. 4 is a diagram representing one example of grouping;

FIG. 5 is a diagram representing an outline of a decision procedure of representative indexes;

FIG. 6 is a flowchart of representative index decision processing by an anomaly detection management apparatus according to embodiment 1;

FIG. 7 is a diagram for explaining operation of profile harvesting;

FIG. 8 is a diagram representing information acquired based on profiling in a VM host;

FIG. 9 is a diagram representing one example of features when functions are used; and

FIG. 10 is a hardware configuration diagram of an anomaly detection management apparatus.

### DESCRIPTION OF EMBODIMENTS

In the related art, because the number of performance indexes used for continuous monitoring amounts to hundreds to thousands in the cloud environment, processing of data and analysis processing take a long time and the time interval of execution of anomaly determination becomes coarse in many cases. For example, in existing actual operation, the time granularity of anomaly determination in the cloud environment is frequently set to the one-hour unit or the like. As above, in the existing method of failure detection in the cloud environment, it is difficult to carry out anomaly detection having immediacy and improve the reliability of the system.

Furthermore, in existing narrowing-down of the performance indexes of the monitoring target, the performance indexes are narrowed down based on experience and knowledge of the administrator. However, in the case of the narrowing-down by the administrator, understanding of the relevance and importance of the respective performance indexes is insufficient and many performance indexes still remain even after the narrowing-down is carried out in some cases. For this reason, the anomaly detection takes a long time after all and it is difficult to carry out anomaly detection having immediacy and improve the reliability of the system.

Furthermore, in the technique in which pieces of performance information are collected from pieces of performance information of a computer in accordance with the degree of priority and a threshold that are defined in advance, an effective method for deciding the degree of priority or the threshold is not presented. Thus, the existing narrowing-down will be carried out also in this related art and it is difficult to carry out anomaly detection having immediacy and improve the reliability of the system. Moreover, in the related art in which the reference model having a similar structure is identified based on the representative index and is utilized for creation of the target model, a consideration about the performance indexes is not made. For this reason, it is not easy to use this technique for the narrowing-down of the performance indexes and it is difficult to carry out anomaly detection having immediacy and improve the reliability of the system.

Embodiments of an anomaly detection management apparatus and an anomaly detection management method disclosed by the present application will be described in detail below based on the drawings. The anomaly detection management apparatus and method disclosed by the present application are not limited by the following embodiments.

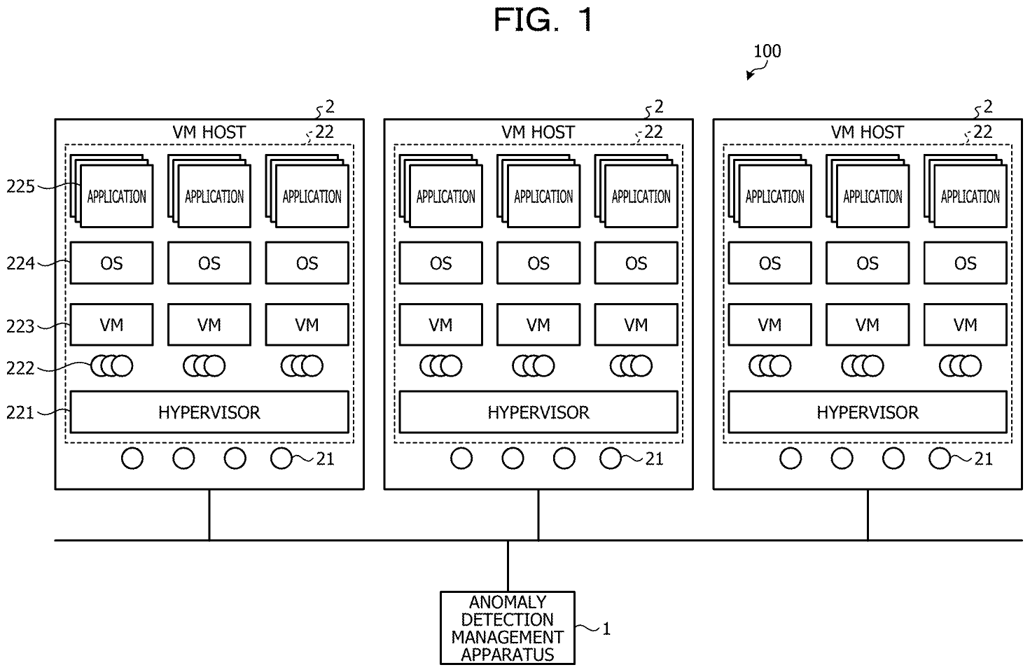

FIG. 1 is a schematic configuration diagram of an information processing system. An information processing system 100 includes an anomaly detection management apparatus 1 and plural VM hosts 2. Each VM host 2 includes plural physical central processing units (CPUs) 21. Furthermore, the VM host 2 includes a virtual environment 22 implemented through execution of a program by the physical CPU 21.

The physical CPU 21 carries out monitoring of performance information specified from the anomaly detection management apparatus 1 as monitoring of operation of the VM host 2. Furthermore, the physical CPU 21 determines that failure has occurred if the value of the performance information surpasses a defined threshold. Moreover, if failure has occurred, the physical CPU 21 raises an alert to notify the administrator of the occurrence of the failure. Hereinafter, the performance information employed as the criterion of determination of whether or not failure occurs will be referred to as “index” of failure detection.

The virtual environment 22 includes a hypervisor 221, virtual CPUs 222, VMs 223, operating systems (OSs) 224, and applications 225.

The hypervisor 221 carries out overall management of the virtual environment 22. The hypervisor 221 manages the virtual CPUs 222, the VMs 223, the OSs 224, and the applications 225.

The virtual CPUs 222 are virtual processors for operating the respective VMs 223. In the VM host 2, one VM 223 operates by one or plural virtual CPUs 222.

The VM 223 is a virtual information processing apparatus. The respective OSs 224 each separately operate in the respective VMs 223. The OSs 224 may be either the same kind of OSs or different kinds of OSs. The application 225 operates on the OS 224. One or plural applications 225 may operate on one OS 224.

The anomaly detection management apparatus 1 is coupled to the plural VM hosts 2 by a network. The anomaly detection management apparatus 1 decides the performance information employed as the monitoring target in each VM host 2 and causes each VM host 2 to carry out failure detection with use of the decided performance information. Details of the anomaly detection management apparatus 1 will be described below.

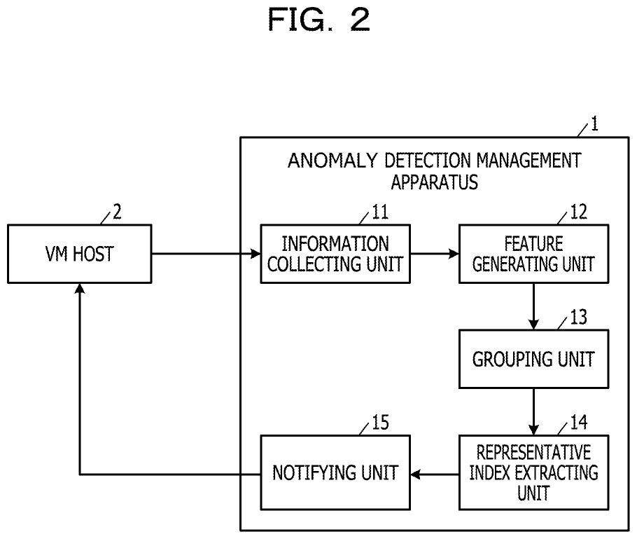

FIG. 2 is a block diagram of an anomaly detection management apparatus. As illustrated in FIG. 2, the anomaly detection management apparatus 1 includes an information collecting unit 11, a feature generating unit 12, a grouping unit 13, a representative index extracting unit 14, and a notifying unit 15. In the following, a description will be made about identification of an index for anomaly detection regarding one VM host 2. However, the anomaly detection management apparatus 1 may carry out the identification regarding each of the plural VM hosts 2. Besides, the anomaly detection management apparatus 1 may use the performance information that is decided regarding one VM host 2 and is used for anomaly detection for another VM host 2.

The information collecting unit 11 acquires all pieces of performance information acquired in the VM host 2. Here, the performance information is information that represents the operation state of hardware and software when the processing is executed. As the performance information of hardware, information that represents the operation state of the physical CPUs 21 and a memory that is not illustrated in FIG. 1 and an IO device including storage and network is included. Furthermore, as the performance information of software, information that represents the operation state of the hypervisor 221, the virtual CPUs 222, the VMs 223, the OSs 224, and the applications 225 is included. For example, in the performance information of the physical CPUs 21, the number of clock cycles, the number of executed instructions, the number of cache misses, and so forth are included.

The performance information is measured by performance monitoring counter (PMC) registers possessed by the physical CPUs 21. The measurement processing of each piece of performance information is referred to as a performance event. Plural PMC registers are set in each of CPU cores mounted in the physical CPUs 21. Furthermore, the kind of performance information deemed as the measurement target and a privileged mode may be set for each PMC. Here, the privileged mode is information that represents a right range given to operation of acquiring the performance information. In the privileged mode, OS mode and USER mode exist, for example. Moreover, the VM host 2 includes a setting register for setting the kind of performance information deemed as the measurement target and the privileged mode for each PMC.

In the measurement of the performance information, the performance information based on operation in the OS mode and the performance information based on operation in the USER mode may be simultaneously acquired by using an even number of PMCs. For example, assuming that 300 kinds of performance information exist, measurement of all pieces of performance information is completed in 300 seconds when monitoring about operation of generating each piece of performance information is switched every second and one piece of performance information is monitored by using two PMCs simultaneously with switching on every second basis.

The information collecting unit 11 collects pieces of performance information in a period defined in advance. Here, the information collecting unit 11 may repeat the collection of all pieces of performance information plural times. Then, the information collecting unit 11 outputs the collected pieces of performance information to the feature generating unit 12. The information collecting unit 11 is equivalent to one example of “collecting unit.”

The feature generating unit 12 receives input of the respective pieces of performance information in the VM host 2 from the information collecting unit 11. Next, the feature generating unit 12 acquires the number of times of occurrence of each performance event from the number of acquired pieces of performance information. In the present embodiment, the feature generating unit 12 acquires the feature of the number of times of occurrence in the OS mode and the number of times of occurrence in the USER mode regarding each performance event. Here, it may be said that the number of times of occurrence in the OS mode and the number of times of occurrence in the USER mode regarding the performance event are occurrence trends of the performance information.

At this time, the feature generating unit 12 removes a performance event without data, for example, an inactive performance event. Furthermore, if the same event is measured plural times in a given time, the feature generating unit 12 converts the performance event to a unit-time average. Moreover, the feature generating unit 12 removes data with a large variance value.

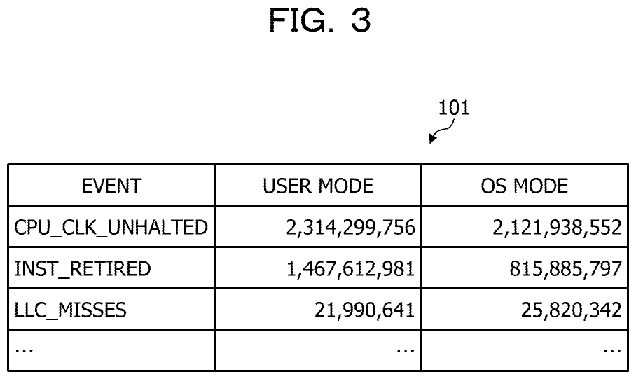

For example, the feature generating unit 12 generates information illustrated in FIG. 3. FIG. 3 is a diagram representing one example of features using OS mode and USER mode regarding performance indexes. CPU_CLK_UNHALTED in a table 101 of FIG. 3 is a performance event of acquiring the number of clocks of the physical CPU 21. The number of times of occurrence in the USER mode regarding this performance event is 2,314,299,756 and the number of times of occurrence in the OS mode is 2,121,938,552.

Next, the feature generating unit 12 normalizes the acquired features of the performance events. For example, the feature generating unit 12 corrects the feature of each performance event through carrying out scaling in such a manner that the standard deviation of the feature of each performance event becomes 1 and carrying out centering in such a manner that the average becomes 0. Besides, if positive and negative signs exist in the feature, either sign may be inversed to unify the signs into one of the positive and negative signs. Then, the feature generating unit 12 outputs the generated feature of each performance event to the grouping unit 13.

The grouping unit 13 receives input of the feature of each performance event from the feature generating unit 12. Then, the grouping unit 13 carries out clustering regarding the acquired features by using a model-based clustering method based on a mixed normal distribution model to create groups. In this case, the number of clusters is also automatically decided based on statistical evidence. For example, the grouping unit 13 carries out the clustering by using the k-means method or the like. Then, the grouping unit 13 outputs information on the performance events included in each group to the representative index extracting unit 14 together with information on the classification of the groups.

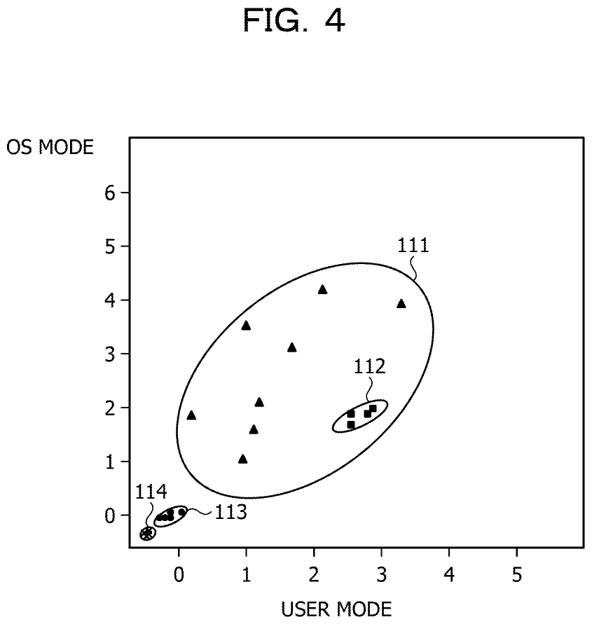

For example, FIG. 4 is a diagram representing one example of grouping. The grouping unit 13 sets the number of times of occurrence in the OS mode on the ordinate axis and sets the number of times of occurrence in the USER mode on the abscissa axis to generate two-dimensional coordinates regarding each of performance events of pieces of performance information that represent CPU performance. Next, the grouping unit 13 plots a dot representing the feature of each performance event on the coordinate space to generate the graph illustrated in FIG. 4. Then, the grouping unit 13 carries out model-based clustering and generates four groups, groups 111 to 114. Performance events represented by triangular dots belong to the group 111. Performance events represented by square dots belong to the group 112. Performance events represented by circular dots belong to the group 113. Performance events represented by cross dots belong to the group 114.

The representative index extracting unit 14 receives input of the information on the performance events included in each group with the information on the classification of the groups from the grouping unit 13. Then, the representative index extracting unit 14 obtains likelihood that is the probability of plausibility of each performance event belonging to a respective one of the groups. For example, the representative index extracting unit 14 may obtain the likelihood of each performance event by the EM algorithm in the model-based clustering processing by the grouping unit 13. It is also possible to rephrase a performance event with higher likelihood into a performance event closer to the center of the group.

Next, the representative index extracting unit 14 extracts the performance event with the highest likelihood regarding each group and employs performance information acquired by the extracted performance event as the representative index of the group. Here, the representative index is performance information that may collectively represent the trend of the running state of the VM host 2 represented by pieces of performance information acquired by all performance events included in a certain group. For example, by understanding the trend of the representative index of the certain group, the trend of all pieces of performance information acquired by the performance events belonging to the group may be understood. This representative index is equivalent to one example of “reference information.”

Here, the reason why the performance information corresponding to the performance event with the highest likelihood is employed as the representative index will be described. This is because it may be said that a performance event with lower likelihood, for example, a performance event with higher uncertainty, is located in a boundary region between clusters more readily and therefore the possibility of erroneous classification of the group becomes higher with the performance event with lower likelihood. Here, uncertainty=1−likelihood holds.

Furthermore, although the performance event with the highest likelihood is extracted in the present embodiment, the possibility of erroneous classification may be suppressed to a low possibility when the likelihood is high and therefore performance information corresponding to another performance event may be employed as the representative index as long as it is a performance event with likelihood close to the highest likelihood.

Thereafter, the representative index extracting unit 14 outputs the representative index of each group to the notifying unit 15 together with the classification of the groups. The representative index extracting unit 14 is equivalent to one example of “extracting unit.”

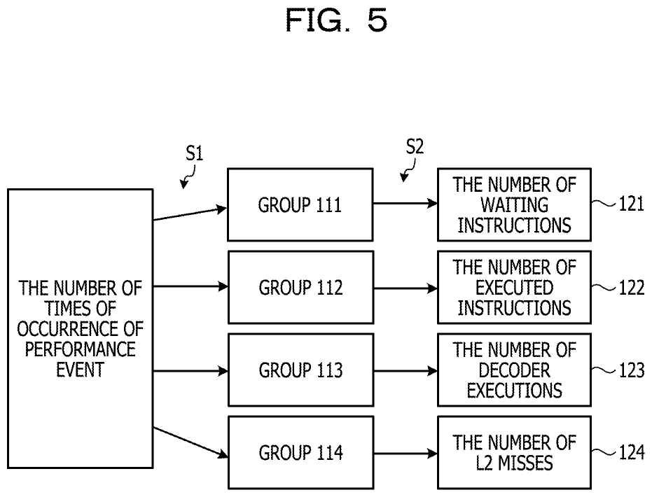

For example, FIG. 5 is a diagram representing an outline of a decision procedure of representative indexes. Here, a description will be made by taking as an example acquisition of the representative indexes relating to pieces of performance information that represent CPU performance similarly to FIG. 4. First, the information collecting unit 11 acquires the number of times of occurrence of each performance event by which the performance information that represents CPU performance is acquired. Then, the grouping unit 13 carries out clustering for the features of the pieces of performance information (step S1) and generates the groups 111 to 114 illustrated in FIG. 4.

Then, the representative index extracting unit 14 extracts the representative indexes regarding the respective groups 111 to 114 (step S2). For example, the representative index extracting unit 14 extracts the number of waiting instructions as a representative index 121 of the group 111. Furthermore, the representative index extracting unit 14 extracts the number of executed instructions as a representative index 122 of the group 112. Moreover, the representative index extracting unit 14 extracts the number of decoder executions as a representative index 123 of the group 113. In addition, the representative index extracting unit 14 extracts the number of L (Layer) 2 misses as a representative index 124 of the group 114.

Here, the representative indexes 121 to 123 are pieces of performance information of the instruction system that directly represent the state of the physical CPU 21. In contrast, the number of L2 misses of the representative index 124 is performance information of the memory system and is not information that directly represents the state of the physical CPU 21. Here, when the administrator decides the representative index from the past experience, it is difficult to use performance information of the memory system as the representative index that represents the state of the physical CPU 21. As above, the anomaly detection management apparatus 1 according to the present embodiment may select, as the representative index, performance information that is difficult to extract as the representative index by the administrator from the past experience, and set more appropriate performance information as the index for anomaly detection.

The notifying unit 15 receives the notification of the representative index of each group from the representative index extracting unit 14 together with the classification of the groups. Then, the notifying unit 15 transmits information on the representative index of each group to the VM host 2 together with the classification of the groups. Thereby, the notifying unit 15 causes the VM host 2 to carry out failure detection by use of the notified representative indexes. The notifying unit 15 is equivalent to one example of “anomaly detection control unit.”

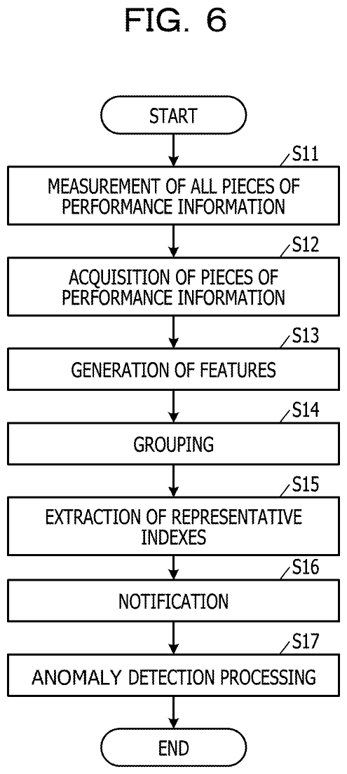

Next, with reference to FIG. 6, the flow of representative index decision processing by the anomaly detection management apparatus 1 according to the present embodiment will be described. FIG. 6 is a flowchart of representative index decision processing by an anomaly detection management apparatus according to embodiment 1.

The VM host 2 measures all pieces of performance information and transmits them to the anomaly detection management apparatus 1 (step S11).

The information collecting unit 11 collects all pieces of performance information in the VM host 2 (step S12). Then, the information collecting unit 11 outputs the collected pieces of performance information to the feature generating unit 12.

The feature generating unit 12 receives input of the pieces of performance information of the VM host 2 collected by the information collecting unit 11 from the information collecting unit 11. Then, the feature generating unit 12 counts the acquired pieces of performance information regarding each of the OS mode and the USER mode and acquires the number of times of occurrence of each performance event in the OS mode and the number of times of occurrence of each performance event in the USER mode. Next, the feature generating unit 12 normalizes the acquired number of times of occurrence of each performance event in the OS mode and the acquired number of times of occurrence of each performance event in the USER mode and generates features (step S13). Thereafter, the feature generating unit 12 outputs the generated feature of each performance event to the grouping unit 13.

The grouping unit 13 receives input of the feature of each performance event from the feature generating unit 12. Then, the grouping unit 13 carries out grouping for the acquired feature of each performance event by using a model-based clustering method (step S14). Thereafter, the grouping unit 13 outputs information on the classification of groups and information on the performance events belonging to each group to the representative index extracting unit 14.

The representative index extracting unit 14 receives input of the information on the classification of groups and the information on the performance events that belong to each group from the grouping unit 13. Then, the representative index extracting unit 14 extracts, in each group, the performance event with the highest likelihood in the performance events belong to the group and extracts the performance information corresponding to the performance event as the representative index (step S15). Thereafter, the representative index extracting unit 14 outputs information on the extracted representative index of each group to the notifying unit 15.

The notifying unit 15 receives input of the information on the representative index of each group from the representative index extracting unit 14. Then, the notifying unit 15 notifies the acquired information on the representative index of each group to the VM host 2 (step S16).

The VM host 2 receives the notification of the information on the representative index of each group from the notifying unit 15. Then, the VM host 2 executes anomaly detection by using the acquired representative indexes (step S17). For example, the VM host 2 measures pieces of performance information employed as the representative indexes and informs the administrator of the occurrence of failure if the measurement result surpasses a threshold defined in advance.

As described above, the anomaly detection management apparatus according to the present embodiment generates a feature regarding each of pieces of performance information measured by the VM host and divides the generated features into several groups to decide the representative indexes in the groups. Moreover, the anomaly detection management apparatus according to the present embodiment causes the VM host to carry out anomaly detection by use of the decided representative indexes. This allows the anomaly detection management apparatus according to the present embodiment to extract indexes suitable for monitoring of the actual operation situation and anomaly detection with narrowing-down of the number of indexes without depending on experience and so forth of the administrator and it becomes possible to cause each VM host to carry out anomaly detection having immediacy. For example, when the anomaly detection management apparatus according to the present embodiment is used, each VM host may carry out anomaly detection having immediacy in units of seconds or in units of minutes.

For example, about the case in which 800 kinds of performance information exist, the anomaly detection management apparatus according to the present embodiment and the related art that measures all pieces of performance information and carries out anomaly detection are compared. In this case, the anomaly detection management apparatus according to the present embodiment may make the monitoring time interval be approximately one-thirtieth compared with the related art and shortening of the monitoring time interval becomes possible. Furthermore, the anomaly detection management apparatus according to the present embodiment may suppress erroneous detection to approximately one-seventh compared with the related art and reduction in erroneous detection becomes possible. Moreover, the anomaly detection management apparatus according to the present embodiment may make the time of initial learning be approximately one-fourth compared with the case in which the administrator decides the representative indexes based on experience and shortening of the initial learning time becomes possible. This allows the anomaly detection management apparatus according to the present embodiment to cause the VM host to detect instantaneous abnormalities such as the CPU load and memory depletion, which are difficult to detect in anomaly detection by use of a large number of indexes.

Furthermore, the anomaly detection management apparatus according to the present embodiment may use performance information relating to a specific part as the index that expresses the state of the specific part, and besides, performance information that may express the whole of the system deemed as the target. For this reason, anomaly detection is based on experience of the administrator, and besides, for example, even when unknown performance information is included, the performance information may be used for anomaly detection.

Next, embodiment 2 will be described. An anomaly detection management apparatus according to the present embodiment is different from embodiment 1 in the generation method of the feature. The anomaly detection management apparatus according to the present embodiment is also represented by a block diagram of FIG. 2. In the following, description is omitted about functions of the respective parts similar to that of embodiment 1.

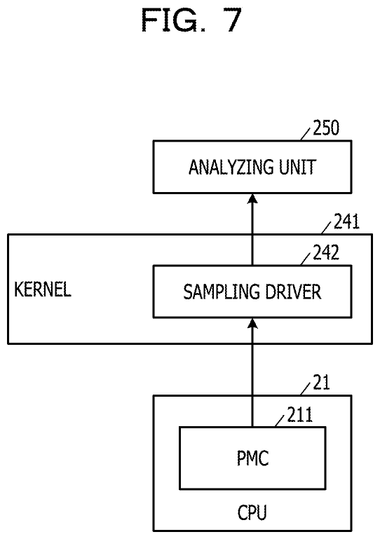

The VM host 2 carries out profile harvesting. FIG. 7 is a diagram for explaining operation of profile harvesting. A kernel 241 operates on the OS 224. Furthermore, the function of carrying out the profile harvesting is implemented as a sampling driver 242 that is a module driver at the kernel level.

The sampling driver 242 harvests operation information of a program that operates on the VM host 2 at certain intervals. For example, a PMC 211 issues an overflow interrupt of the counter of the register to the sampling driver 242. The sampling driver 242 employs the overflow interrupt issued from the PMC 211 as a trigger to harvest identification information of the program that operates at the time. For example, if the overflow interrupt is generated every 1 msec, the sampling driver 242 harvests the identification information of the program that is operating at a cycle of 1 msec. Here, the identification information of the program is the program identifier (PID) or instruction address, for example. Then, the sampling driver 242 transmits the acquired identification information of the program that is operating to an analyzing unit 250.

The analyzing unit 250 acquires the identification information of the program from the sampling driver 242 at certain intervals. Then, the analyzing unit 250 acquires a program name and information on a function used at the time from the identification information of the program. For example, the analyzing unit 250 acquires the program name from the PID and acquires the function name from the instruction address.

Next, the analyzing unit 250 obtains the CPU usage of each function in each program from the program name and the information on the function used at the time, acquired at the certain intervals in a given period. In this case, the CPU usage is performance information.

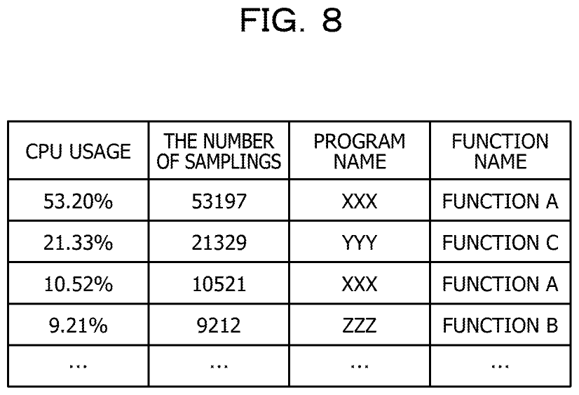

Then, as illustrated in FIG. 8, in decreasing order of the CPU usage, the analyzing unit 250 lines up the program name, the function name, and the number of samplings corresponding to the CPU usage. FIG. 8 is a diagram representing information acquired based on profiling in a VM host. For example, the analyzing unit 250 may obtain the number of samplings in the given period of the present round by subtracting the number of samplings to the time of the previous round of acquisition of performance information from the number of samplings of the present round. This number of samplings is equivalent to the number of times of occurrence of the performance event by which each piece of performance information is acquired. However, the calculation method of the number of samplings may be another method. For example, the analyzing unit 250 may initialize the counter at the beginning of the given period and count the number of samplings in the given period.

Here, although description is made in the present embodiment with the case in which the CPU usage is acquired as performance information, it is also possible for the analyzing unit 250 to acquire another kind of information. For example, when each program accesses a storage, it is also possible for the analyzing unit 250 to obtain the throughput and latency with respect to the storage by using information acquired from the sampling driver 242.

Then, the analyzing unit 250 transmits, to the information collecting unit 11 of the anomaly detection management apparatus 1, each piece of performance information and the number of samplings, the program name, and the function name corresponding to the performance information like those represented in FIG. 8.

The information collecting unit 11 acquires the number of samplings, the program name, and the function name corresponding to each piece of performance information from the analyzing unit 250 of the VM host 2. The information collecting unit 11 accumulates the acquired pieces of performance information until all pieces of performance information are sent. Thereafter, regarding all pieces of performance information, the information collecting unit 11 outputs the number of samplings, the program name, and the function name corresponding to each piece of performance information to the feature generating unit 12.

Here, although the VM host 2 calculates the performance information corresponding to the program name and the function name and acquires the number of samplings in the present embodiment, the feature generating unit 12 may analyze the sampling information.

The feature generating unit 12 receives input of the number of samplings, the program name, and the function name corresponding to each piece of performance information from the information collecting unit 11 regarding all pieces of performance information. Next, the feature generating unit 12 acquires the function names ranked in the top four in each piece of performance information. Here, it suffices to select the function names of functions having a large influence on the performance information as the acquired function names. For example, the feature generating unit 12 may acquire the function names that occupy upper 90% in each piece of performance information.

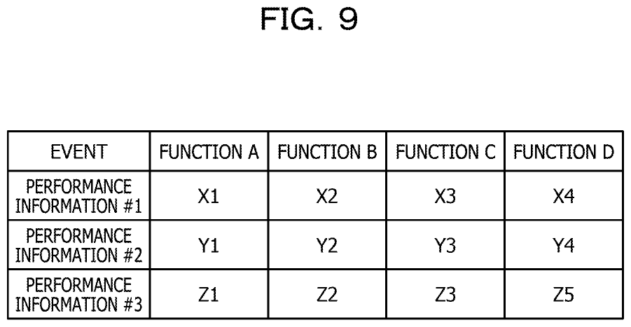

Then, the feature generating unit 12 acquires the number of samplings corresponding to each function as the number of times of occurrence of performance event corresponding to the function. Then, regarding each piece of performance information, the feature generating unit 12 tallies up the number of times of occurrence on each function basis. For example, the feature generating unit 12 generates information like that illustrated in FIG. 9. FIG. 9 is a diagram representing one example of features when functions are used. FIG. 9 represents the number of times of occurrence of each of functions having function names of functions A to D regarding each piece of performance information.

Then, the feature generating unit 12 employs the number of times of occurrence of each function regarding each piece of performance information as the feature of the performance event by which each piece of performance information is acquired. For example, in this case, the feature generating unit 12 generates the feature having the same number of dimensions as the number of functions. For example, the features represented in FIG. 9 are four-dimensional features. Thereafter, the feature generating unit 12 normalizes the calculated features and outputs the normalized features to the grouping unit 13.

The grouping unit 13 receives input of the features from the feature generating unit 12. Then, the grouping unit 13 uses a model-based clustering method for the features of the respective performance events to generate groups. For example, when having the features like those represented in FIG. 9, the grouping unit 13 carries out the grouping of the respective performance events by using a four-dimensional coordinate space having the numbers of times of occurrence of the four functions represented as functions A to D as the coordinate axes.

Thereafter, regarding each of the groups generated by the grouping unit 13, the representative index extracting unit 14 extracts, as the representative index, the performance information acquired by the performance event with the highest likelihood from the performance events belonging to each group. Then, the notifying unit 15 notifies the representative indexes extracted by the representative index extracting unit 14 to the VM host 2 and causes the VM host 2 to carry out anomaly detection by use of the representative indexes.

As described above, the anomaly detection management apparatus according to the present embodiment employs, as the feature, the number of times of occurrence of the performance event regarding each of functions with which the respective performance events have been carried out and carries out grouping. Then, the anomaly detection management apparatus decides the representative index regarding each group and causes the VM host to carry out anomaly detection. As above, the representative index may be decided also by using the number of times of occurrence of the performance event regarding each of functions besides the features using the OS mode and the USER mode. Furthermore, also in this case, the representative index may properly represent the trend of the performance events included in the group to which the representative index belongs and proper anomaly detection may be carried out through monitoring of a small number of pieces of performance information.

Moreover, although the feature having the number of dimensions equal to or larger than two is used in the above description, a one-dimensional feature may be used. In this case, it is also possible to use the unchanged value of the performance information as the feature.

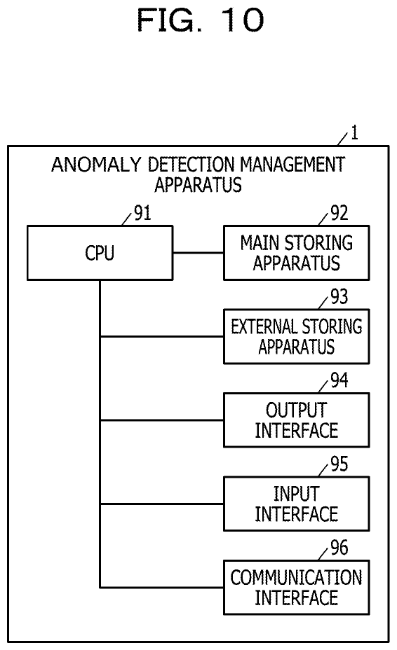

Next, with reference to FIG. 10, the hardware configuration of the anomaly detection management apparatus 1 will be described. FIG. 10 is a hardware configuration diagram of an anomaly detection management apparatus. The anomaly detection management apparatus 1 includes a CPU 91, a main storing apparatus 92, an external storing apparatus 93, an output interface 94, an input interface 95, and a communication interface 96.

The CPU 91 is coupled to the main storing apparatus 92, the external storing apparatus 93, the output interface 94, the input interface 95, and the communication interface 96 by a bus. The CPU 91 communicates with the main storing apparatus 92, the external storing apparatus 93, the output interface 94, the input interface 95, and the communication interface 96 through the bus.

The communication interface 96 is an interface for communication with an external apparatus including the VM host 2. The CPU 91 communicates with the VM host 2 through the communication interface 96.

An Output apparatus such as a display is coupled to the output interface 94. Furthermore, an input apparatus such as mouse and keyboard is coupled to the input interface 95. However, a normally input apparatus and an output apparatus are not coupled to the output interface 94 and the input interface 95 and input and output to and from the anomaly detection management apparatus 1 are carried out with an external apparatus through the communication interface 96.

The external storing apparatus 93 is an auxiliary storing apparatus such as hard disk and solid state drive. The external storing apparatus 93 stores various kinds of programs including a program including plural instructions for implementing functions of the information collecting unit 11, the feature generating unit 12, the grouping unit 13, the representative index extracting unit 14, and the notifying unit 15 exemplified in FIG. 2.

The main storing apparatus 92 is a memory such as a dynamic random access memory (DRAM). The CPU 91 reads out, from the external storing apparatus 93, various kinds of programs including the program including plural instructions for implementing functions of the information collecting unit 11, the feature generating unit 12, the grouping unit 13, the representative index extracting unit 14, and the notifying unit 15 exemplified in FIG. 2 and loads the various kinds of programs into the main storing apparatus 92 to execute them. Thereby, the CPU 91 implements the functions of the information collecting unit 11, the feature generating unit 12, the grouping unit 13, the representative index extracting unit 14, and the notifying unit 15 exemplified in FIG. 2.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An anomaly detection management apparatus comprising:
one or more memories; and
one or more processors coupled to the one or more memories and the one or more processors configured to
perform acquisition of a plurality of pieces of performance information that represent a running state of a computer,
perform identification of a plurality of features that represent an occurrence trend of each piece of the plurality of pieces of performance information,
perform classification of the plurality of pieces of performance information in accordance with the plurality of features,
for each group generated by the classification, perform selection of specific piece of performance information as a criterion of anomaly detection from one or more pieces of performance information included in each group, and
notify the specific piece of performance information to the computer and cause the computer to perform anomaly detection by using the specific piece of performance information.

2. The anomaly detection management apparatus according to claim 1, wherein
the acquisition includes acquiring the plurality of pieces of performance information in accordance with a specified right range.

3. The anomaly detection management apparatus according to claim 1, wherein
the identification is executed in accordance with functions running when each of the plurality of pieces of performance information is acquired.

4. The anomaly detection management apparatus according to claim 1, wherein
the classifying is executed by clustering the plurality of features.

5. The anomaly detection management apparatus according to claim 1, wherein
the selection includes selecting the specific piece of performance information in the one or more pieces of performance information included in each group in accordance with likelihood that each of the one or more pieces of performance information is included in each group.

6. The anomaly detection management apparatus according to claim 5, wherein
the specific piece of performance information is a piece of performance information with highest likelihood in the one or more pieces of performance information.

7. A computer-implemented anomaly detection management method comprising:
acquiring a plurality of pieces of performance information that represent a running state of a computer;
identifying a plurality of features that represent an occurrence trend of each piece of the plurality of pieces of performance information;
classifying the plurality of pieces of performance information in accordance with the plurality of features;
for each group generated by the classification, selecting specific piece of performance information as a criterion of anomaly detection from one or more pieces of performance information included in each group; and
notifying the specific piece of performance information to the computer and causing the computer to perform anomaly detection by using the specific piece of performance information.

8. The anomaly detection management method according to claim 7, wherein
the acquiring includes acquiring the plurality of pieces of performance information in accordance with a specified right range.

9. The anomaly detection management method according to claim 7, wherein
the identifying is executed in accordance with functions running when each of the plurality of pieces of performance information is acquired.

10. The anomaly detection management method according to claim 7, wherein
the classifying is executed by clustering the plurality of features.

11. The anomaly detection management method according to claim 7, wherein
the selecting includes selecting the specific piece of performance information in the one or more pieces of performance information included in each group in accordance with likelihood that each of the one or more pieces of performance information is included in each group.

12. The anomaly detection management method according to claim 11, wherein
the specific piece of performance information is a piece of performance information with highest likelihood in the one or more pieces of performance information.

13. A non-transitory computer-readable medium storing instructions executable by one or more computers, the instructions comprising:
one or more instructions for acquiring a plurality of pieces of performance information that represent a running state of a computer;
one or more instructions for identifying a plurality of features that represent an occurrence trend of each piece of the plurality of pieces of performance information;
one or more instructions for classifying the plurality of pieces of performance information in accordance with the plurality of features;
one or more instructions for selecting, for each group generated by the classification, specific piece of performance information as a criterion of anomaly detection from one or more pieces of performance information included in each group; and
one or more instructions for notifying the specific piece of performance information to the computer and causing the computer to perform anomaly detection by using the specific piece of performance information.
